(19) United States
(12) Patent Application Publication
(10) Pub. No.: US 2008/0171546 A1
(43) Pub. Date: Jul. 17, 2008

(54) COMMUNICATION METHOD AND APPARATUS IN COGNITIVE RADIO ENVIRONMENT

(75) Inventors: Tae In HYON, Hwaseong-si (KR); Jae Myoung Kim, Seoul (KR); Jae Hak Chung, Seoul (KR); Sang Jo Yoo, Incheon (KR); Sung Hwan Sohn, Incheon (KR)

Correspondence Address: STEIN, MCEWEN & BUI, LLP, 1400 EYE STREET, NW, SUITE 300, WASHINGTON, DC, 20005, US

(73) Assignees: Samsung Electronics Co., Ltd., Suwon-si (KR); INHA-INDUSTRY PARTNERSHIP INSTITUTE, Inha University, Incheon (KR)

(21) Appl. No.: 11/766,422

(22) Filed: Jun. 21, 2007

(30) Foreign Application Priority Data
Jan. 11, 2007 (KR) 2007-3470

(51) Int. Cl. H04Q 7/20

(52) U.S. Cl. 455/434

(57) ABSTRACT

Aspects of the present invention relate to a communication method and apparatus in a cognitive radio (CR) environment, the method including: receiving an uplink signal that is repeatedly transmitted via at least one candidate channel that is not being used; determining whether the receiving of the uplink signal is due to an existence of an incumbent user using a CR channel of the target cell; and changing the CR channel of the target cell when the receiving of the uplink signal is due to the existence of the incumbent user using the CR channel of the target cell.

### CROSS-REFERENCE TO RELATED APPLICATION

This application claims the benefit of Korean Patent Application No. 2007-3470, filed Jan. 11. 2007 in the Korean Intellectual Property Office, the disclosure of which is incorporated herein by reference.

### BACKGROUND OF THE INVENTION

1. Field of the Invention

Aspects of the present invention relate to a communication method and apparatus in a cognitive radio (CR) environment and more particularly, to a communication method and apparatus in a CR environment where an incumbent user can use a corresponding frequency in the CR environment without an interference phenomenon.

2. Description of the Related Art

Due to the rapid development of wireless communication technologies, most frequency bands that are actually available (particularly low frequency bands) are currently already assigned. To overcome such a shortage, cognitive radio (CR) technology has been proposed as a solution. In the CR technology, assigned frequencies that are not actually used are sensed and various devices can share the sensed frequencies.

Cost efficiency is one of the advantages of CR technologies. Specifically, compared to existing wireless communication services, CR technologies are relatively low priced by using wireless frequency bands with no charge. CR technologies are related to the management and distribution of wireless channels with respect to multi-channels and to interference detection technologies, which may be interoperable with next generation wireless communication. As an example, CR technologies may efficiently transmit high speed data in dead zones without generating frequency interferences. In this instance, the dead zones are created in cellular environments, or rural areas are required to improve cell sizes.

FIG. 1 is a diagram illustrating a neighbor cell 150 and a target cell 100 in a CR environment according to a conventional art. Referring to FIG. 1, a process where an interference phenomenon inevitably occurs due to an incumbent user 152 that exists in the neighbor cell 150 in the CR environment according to the conventional art is described.

As illustrated in FIG. 1, a base station 101 of the target cell 100 using a CR technology provides a communication service to terminals 102 and 103 in the target cell 100 through a channel X. In this case, an incumbent user 152 exists in the neighbor cell 150 or an incumbent user 153, which occupies a portion of a cell adjacent to the neighbor cell 152, exists also using the channel X. The incumbent user 152 or 153 is a user having a primary authority to use a particular channel.

The incumbent users 152 and 153 are located in the neighbor cell 150. However, the incumbent user 152 and 153 may be interfered with by a strong power of an uplink signal of the terminals 102 and 103 that are located outside of the neighbor cell 150. Because the incumbent users 152 and 153 have the primary authority to use the channel X, a user (such as the terminals 102 or 103) and a system (such as the base station 101) of the CR technology should not interfere with the incumbent users 152 and 153. Accordingly, when the incumbent users 152 and 153 exist, the base station 101 using the CR technology must change the channel.

As a result, a communication method and apparatus in the CR environment according to the conventional art has following disadvantages. When an incumbent user 152 or 153 using a same channel as terminals 102 and 103 in a CR environment exists, a base station 101 using the CR technology must first rapidly determine whether the incumbent user 152 exists to quickly change a channel. However, a communication method and apparatus in the CR environment according to the conventional art can not rapidly determine the existence of the incumbent user 152 or 153. Particularly, as illustrated in FIG. 1, the incumbent user 152 or 153 may be a low power incumbent user having a small range from 100 m to 200 m such that low power is used. That is, power used by the incumbent user 152 or 153 may be less than the power needed to cover the cell. Furthermore, a range 104 that can be sensed by the terminals 102 and 103 in the target cell 100 may also be limited. Thus, the incumbent user 152 or 153 may not be sensed and a channel may not change. The low power incumbent user may be an incumbent user using a wireless microphone signal, a part 74 signal, etc.

A method of using a beacon or raising a reliability of a sensing result is considered so that a CR base station can quickly and accurately determine a presence of the low power incumbent user or an incumbent user. However, an additional cost must be spent in building a network when using the beacon, and sensing algorithms become complex and errors increase when raising the reliability of the sensing result. Thus, a communication method and apparatus in a CR environment is needed.

### SUMMARY OF THE INVENTION

Aspects of the present invention provide a communication method and apparatus in a cognitive radio (CR) environment that can quickly change a CR channel from a same channel that an incumbent user uses when the incumbent user or a low power incumbent user exists. Aspects of the present invention also provide a communication method and apparatus in a CR environment that can reduce costs and decrease errors.

According to an aspect of the present invention, there is provided a communication method in a cognitive radio (CR) environment, the method including: receiving a signal that is repeatedly transmitted via at least one candidate channel that is not being used; determining whether the receiving of the signal is due to an existence of an incumbent user using a CR channel of a target cell; and changing the CR channel of the target cell when the receiving of the uplink signal is due to the existence of the incumbent user using the CR channel of the target cell.

According to another aspect of the present invention, there is provided a communication method in a CR environment, the method including: receiving a signal that is repeatedly transmitted via a channel that is used by an incumbent user when the incumbent user using exists in a neighbor cell and the channel that is used by the incumbent user is a CR channel of a target cell; and changing the CR channel of the target cell when the signal is received.

According to another aspect of the present invention, there is provided a communication apparatus in a CR environment, the apparatus including: a receiving unit to receive a signal that is repeatedly transmitted via at least one candidate channel that is not being used; a determination unit to determine whether the signal is received due to an existence, in a neighbor cell, of an incumbent user using a CR channel of the target cell; and a change unit to change the CR channel of the target cell when the signal is received due to the existence of the incumbent user using the CR channel of the target cell.

According to still another aspect of the present invention, there is provided a communication apparatus in a CR environment, the apparatus including: a receiving unit to receive a signal that is repeatedly transmitted via a channel that is used by an incumbent user when the incumbent user exists in a neighbor cell and the channel that is used by the incumbent user is a CR channel of a target cell; and a change unit to change the CR channel of the target cell when the signal is received.

According to yet another aspect of the present invention, there is provided a communication method in a CR environment, the method including: monitoring one or more channels to determine if an incumbent user in a neighbor cell is using a CR channel of a target cell; and changing the CR channel of the target cell when the incumbent user is using the CR channel.

According to another aspect of the present invention, there is provided a communication method that identifies an incumbent user in a neighbor cell of a CR environment, the method including: monitoring a CR channel that is used in a target cell adjacent to the neighbor cell to determine if the incumbent user using the CR channel exists; and transmitting a signal via one or more channels to inform the target cell that the incumbent user using the CR channel exists if the incumbent user using the CR channel does exist.

According to still another aspect of the present invention, there is provided a communication system that identifies an incumbent user in a neighbor cell of a CR environment, the system including: a monitoring unit to monitor a CR channel that is used in a target cell adjacent to the neighbor cell to determine if the incumbent user using the CR channel exists; and a transmitting unit to transmit a signal via one or more channels to inform the target cell that the incumbent user using the CR channel exists if the incumbent user using the CR channel does exist.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a neighbor cell and a target cell in a CR environment according to a conventional art;

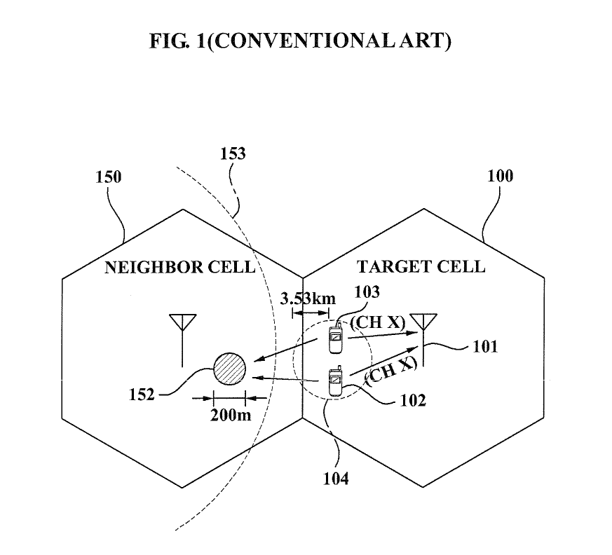

FIG. 2 is a diagram illustrating a neighbor cell and a target cell in a CR environment according to an embodiment of the present invention;

FIG. 3 is a flowchart illustrating a method for a neighbor cell to report to a target cell on whether an incumbent user exists according to an embodiment of the present invention;

FIG. 4 is a flowchart illustrating a method for a target cell to determine whether an incumbent user exists according to an embodiment of the present invention;

FIG. 5 is a diagram illustrating a neighbor cell and a target cell in a CR environment according to another embodiment of the present invention; and

FIG. 6 is a flowchart illustrating a method for a neighbor cell to report to a target cell whether an incumbent user exists according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

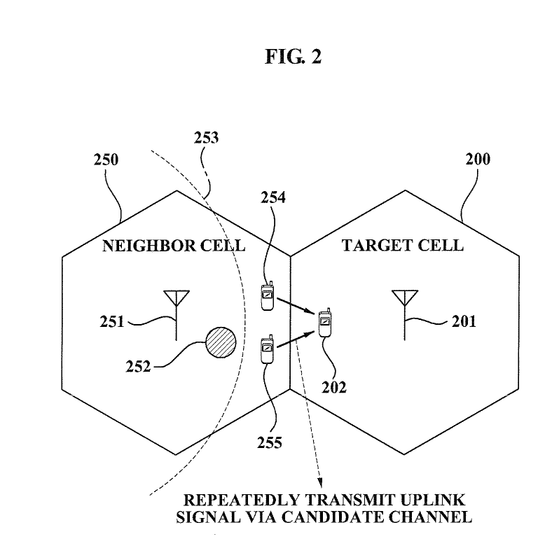

FIG. 2 is a diagram illustrating a neighbor cell and a target cell in a CR environment according to an embodiment of the present invention. Referring to FIG. 2, when an incumbent user 252 or 253 that uses a same channel as a CR channel exists in a neighbor cell 250 while a target cell 200 uses the CR channel, an operation of changing the CR channel is described. In the present specification, the CR channel refers to a currently used frequency band according to a CR technology.

In a system using the CR technology, cells may have information about a frequency usage status of adjacent cells in order to efficiently share a wireless resource among users using the CR technology. Accordingly, as illustrated in FIG. 2, a neighbor cell 250 should sense a frequency of an adjacent cell (for example, a target cell 200) by performing a spectrum sensing.

When an incumbent user or incumbent users 252 and 253 that use a frequency (or channel) of the target cell 200 adjacent to the neighbor cell 250, exists, terminals 254 and 255 in the neighbor cell 250 repeatedly transmit a signal via a candidate channel to improve an efficiency of a dynamic frequency assignment. According to an aspect of the present invention, the signal that the terminals 254 and 255 repeatedly transmit is an uplink signal.

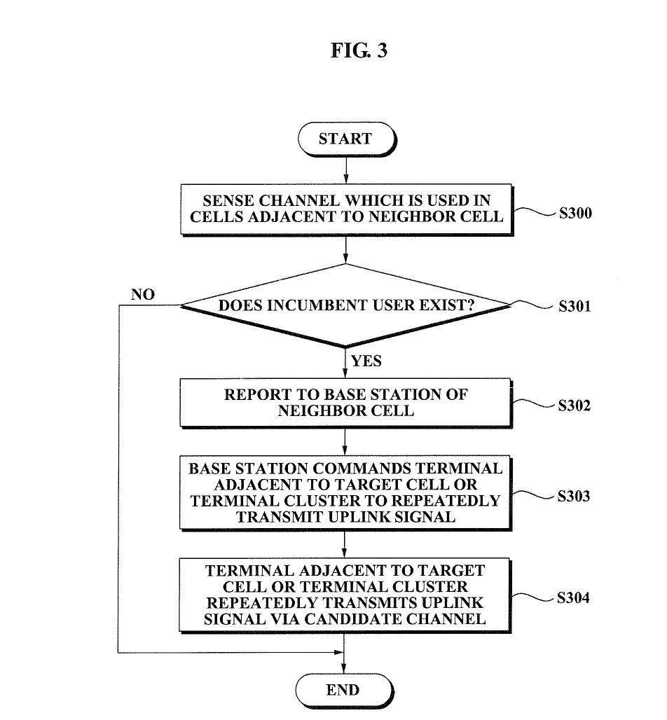

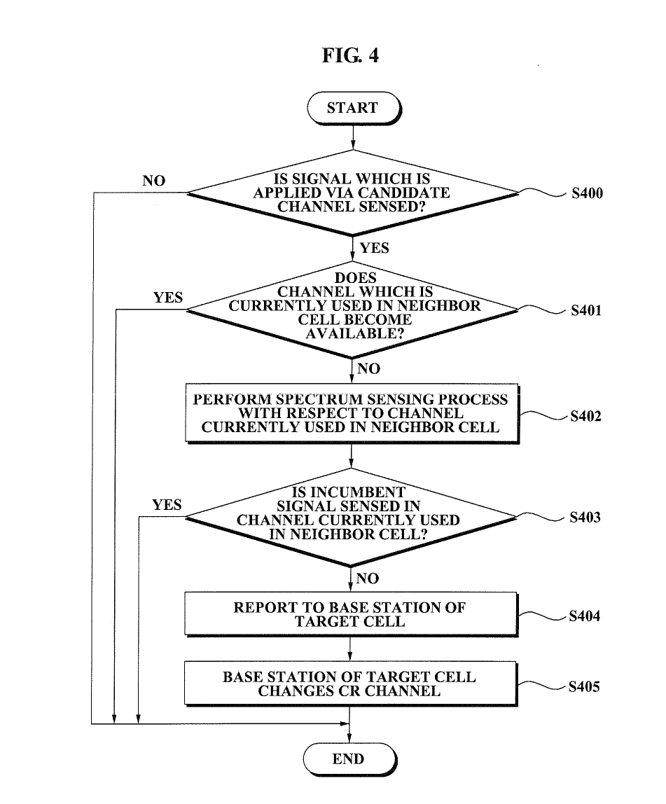

A terminal 202 and/or a base station 201 of the target cell 200 monitor the candidate channel in order to sense the signal. When the signal is sensed in the candidate channel, the terminal 202 and/or the base station 201 determine whether the signal is due to the existence of the incumbent user 252 or 253. Accordingly, the terminal 202 and/or the base station 201 change a CR channel when the signal is due to the existence of the incumbent user 252 or 253. The monitoring of the candidate channel, the determining of whether the signal is due to the incumbent user 252 or 253, and the changing of the CR channel are described in detail with reference to FIGS. 3 and 4. Also, the terminals 202, 254, and 255 are devices, such as a mobile phone, that can communicate with a base station. The candidate channel is a channel that is not currently used and can be used as an active channel, which will be described in detail later.

FIG. 3 is a flowchart illustrating a method for a neighbor cell to report to a target cell on whether an incumbent user exists according to an embodiment of the present invention. In operation S300, a terminal of the neighbor cell senses or monitors a channel that is used in cells adjacent to the neighbor cell in a silent period to determine whether an incumbent user or a low power incumbent user exists. If the incumbent user exists, the incumbent user uses the channel used in the cells adjacent to the neighbor cell. It is understood that according to aspects of the present invention, the sensing of the channel refers to sensing a frequency. The cells adjacent to the neighbor cell may include a target cell.

In operation S301, the terminal of the neighbor cell determines whether the incumbent user exists according to the sensing of the channel (operation S300). In operation S302, the terminal of the neighbor cell reports the result of the determination to a base station of the neighbor cell. Alternatively, it is understood that according to other aspects, the base station may determine whether the incumbent user exists according to the sensing of the channel by the terminal, the base station may sense and/or monitor the channel and determine whether the incumbent user exists, and/or the terminal of the neighbor cell may report to the base station only if the terminal of the neighbor cell does determine that the incumbent user exists.

Next, the base station of the neighbor cell reports the result of the determination to the target cell in operation S303. It is understood that the base station of the neighbor cell may report the result of the determination to the target cell only if it is determined that the incumbent user exists. Accordingly, the base station of the neighbor cell may command the terminal of the neighbor cell (for example, a terminal adjacent to the target cell) to immediately transmit an uplink signal via a candidate channel and/or an uplink channel. The uplink signal is a signal that is transmitted to the base station when uplinking. It is understood that a terminal cluster, which is a pair of terminals, can be used instead of the terminal. The base station of the neighbor cell may, although not necessarily, only command a terminal (or terminal cluster) most adjacent to the target cell to transmit the uplink signal in order to reduce unnecessary interference.

In this case, the terminal adjacent to the target cell (or the one or more terminals receiving the command from the base station) repeatedly transmits the uplink signal via the candidate channel and/or the uplink channel in operation S304. Specifically, the existence of the incumbent user can be easily ascertained by only using the candidate channel without an additional device or additional channel. In the above-described description, using a single candidate channel is described. It is understood that when a plurality of candidate channels exists, an accuracy of signal determination can be improved by transmitting an identical signal using the plurality of candidate channels. However, a method of preventing a signal that is not related to the existence of an incumbent user from being detected in the candidate channel is needed. Such a method is described in detail with reference to FIG. 4.

FIG. 4 is a flowchart illustrating a method for a target cell to determine whether an incumbent user exists according to an embodiment of the present invention. Referring to FIG. 4, the method of determining whether the incumbent user exists is described in detail. Specifically, when a signal is sensed in a candidate channel, a method of determining whether the signal is due to an existence of the incumbent user using a same channel as a CR channel used in the target cell is described. As a result of an experiment of the present invention, a case when the signal is applied to the candidate channel is as follows. First, when a channel changes since the incumbent user exists in a channel used in the neighbor cell, the signal is applied. Second, when a signal to noise ratio (SNR) of the channel used in the neighbor cell is reduced to below a predetermined level, the signal is applied. Third, as described above, when the incumbent user exists in the CR channel used in the target cell, the signal is applied. Also, when the channel changes and the SNR of the channel used in the neighbor cell is reduced, another channel becomes available instead of occupying the candidate channel or a candidate channel group in the neighbor cell. Accordingly, when the channel changes and the SNR of the channel used in the neighbor cell is reduced, whether the signal is detected due to the existence of the incumbent user in the CR channel can be determined by determining whether a channel currently used is used.

As illustrated in FIG. 4, in operation S400, a terminal of the target cell determines whether the signal that is applied via the candidate channel (such as an uplink signal) is sensed. When a signal is sensed in operation S400, the terminal of the target cell determines whether a channel currently used in the neighbor cell becomes available (operation S401). In operation S401, it is determined that a change of the channel currently used in the neighbor cell is due to the existence of the incumbent user in the channel used in the neighbor cell or the reduction of the SNR of the channel used in the neighbor cell. Specifically, when the channel currently used in the neighbor cell becomes available, the availability of the channel may be due to the existence of the incumbent user in the channel used in the neighbor cell or the reduction of the SNR of the channel used in the neighbor cell. Accordingly, in this case, the incumbent user does not exist in the channel used in the target cell and, thus, the CR channel does not need to change.

When the channel currently used in the neighbor cell does not become available (operation S401), then either the incumbent user exists in the channel used in the target cell or an incumbent signal exists in the neighbor cell. Accordingly, to determine which of the two cases exists, a spectrum sensing with respect to the channel currently used in the neighbor cell is performed. Different spectrum sensing results are generated, which can be distinguished by those skilled in related arts, according to the reason that the channel does not become available.

In operation S402, the terminal of the target cell performs a spectrum sensing process with respect to the channel currently used in the neighbor cell. In operation S403, the terminal of the target cell determines whether the incumbent signal is sensed in the channel currently used in the neighbor cell. In operation S404, when the incumbent signal is not sensed (operation S403), the terminal of the target cell reports information about the existence of the incumbent user that uses the CR channel of the target cell to a base station of the target cell. In operation S405, the base station changes the CR channel. When the neighbor cell transmits the signal via a plurality of candidate channels, each of the plurality of candidate channels is used as described above to improve an accuracy of detecting the incumbent user using the same channel that the target cell.

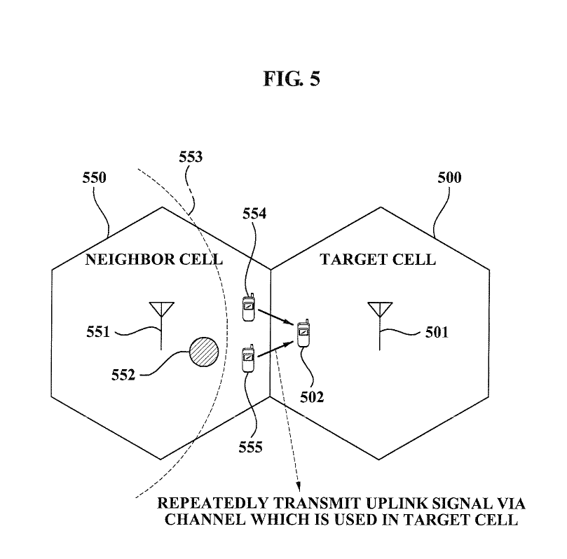

FIG. 5 is a diagram illustrating a neighbor cell and a target cell in a CR environment according to another embodiment of the present invention. Referring to FIG. 5, when an incumbent user that uses a same channel as a CR channel exists in a neighbor cell while the target cell uses the CR channel, an operation of changing the CR channel of the target cell by interfering with a channel that is currently used in the target cell is described in detail.

The embodiment of the present invention described above reports an existence of the incumbent user to a base station of the target cell using a candidate channel. In contrast, another embodiment of the present invention described below changes the CR channel of the target cell by interfering with a channel that is currently used in the target cell. In other words, as described above, an embodiment of the present invention may be applied to a case when a plurality of candidate channels is used, since a number of available channels that can be used in a CR technology is enough. However, when the number of available channels that can be used in the CR technology is limited, applying aspects of the present invention to a plurality of channels is not possible since only a limited number of channels that can be used in the CR technology exist. In this case, aspects of the present invention automatically change the CR channel by interfering with a channel that is used in an adjacent cell (for example, the target cell) and reducing a quality of the CR channel.

In the CR technology, a channel may be classified into one of a few groups to improve a frequency usage efficiency. For example, the channel may be classified as an active channel, a candidate channel, an occupied channel, a not-granted channel, and an etc. channel. The active channel is a channel that is currently used in a base station and a terminal. The candidate channel is a channel that is not currently used, but can be used as the active channel. The occupied channel is a channel that is used by the incumbent user, and thus can not be used for the CR technology. The not-granted channel is a channel that can not be used according to a protocol. The etc. channel refers to all other channels aside from the active channel, the candidate channel, the occupied channel, and the not-granted channel. Specifically, the etc. channel may be a channel having an SNR less than a predetermined level. When an SNR of the candidate channel or the active channel is reduced to below the predetermined level, the classification of the candidate channel or the active channel may be changed to the etc. channel.

As illustrated in FIG. 5, when an incumbent user 552 or incumbent users 552 and 553 exist while occupying a channel of a target cell 500, an interference with respect to the incumbent user 552 or 553 and an incumbent system should be avoided. Accordingly, when the incumbent user 552 or the incumbent users 552 and 553 occupy the channel of the target cell 500, terminals 554 and 555 in the neighbor cell 550 intensively transmit a signal, such as an uplink signal, via the channel of the target cell used by the incumbent user. The terminals 554 and 555 are located around the target cell 500. The uplink may refer to a direction from the terminals 554 and 555 to a base station 551.

Accordingly, a terminal 502 that is located in the target cell 500 and adjacent to the terminals 554 and 555 senses an interference in the channel of the target cell 500 due to the uplink signal. Specifically, the SNR of the channel may be reduced to below a predetermined level. The terminal 502 requests a base station 501 to change the CR channel due to the reduction of the SNR. The base station 501 performs the change of the CR channel.

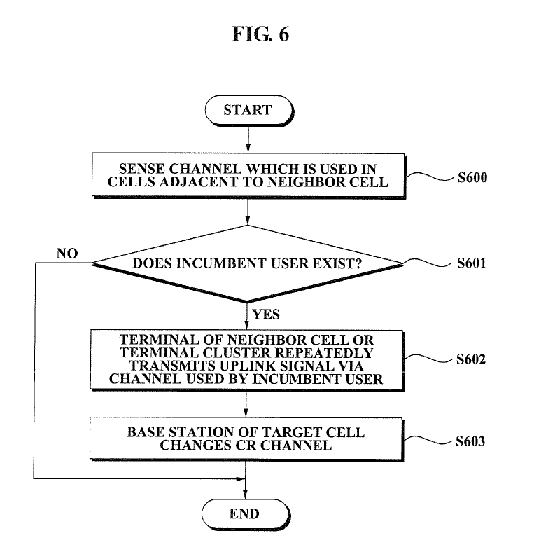

FIG. 6 is a flowchart illustrating a method for a neighbor cell to report to a target cell whether an incumbent user exists according to another embodiment of the present invention. Referring to FIG. 6, the method of reporting to the target cell is described in detail. However, a greater detailed description of the method of reporting is omitted since a number of operations of the method of reporting in FIG. 6 are identical to the description of FIG. 5.

In operation S600, a terminal of a neighbor cell senses or monitors a channel used in cells adjacent to the neighbor cell. According to an aspect of the present invention, the sensing of the channel may refer to sensing a frequency. A target cell may be included in the cells adjacent to the neighbor cell. In operation S601, the terminal or the base station of the neighbor cell determines whether an incumbent user exists according to the sensing of the channel (operation S600).

In operation S602, the terminal of the neighbor cell or a terminal cluster repeatedly transmits an uplink signal via a channel used in the incumbent user when the incumbent user exists. As a result, a terminal of the target cell strongly senses same channel interference, and requests a change of a CR channel from a base station of the target cell. In operation S603, the base station of the target cell receiving the request changes the CR channel.

A communication method and apparatus in a CR environment according to aspects of the present invention easily determines whether an incumbent user or a low power incumbent user exists, and thereby may avoid an interference phenomenon in a CR technology. Moreover, aspects of the present invention may be applied regardless of a number of available candidate channels in a neighbor cell. Furthermore, aspects of the present invention do not require a high-priced beacon to sense an incumbent user, and thereby may reduce a cost. Also, a communication method and apparatus in a CR environment according to aspects of the present invention do not need a complex spectrum sensing technology covering a large area to sense an incumbent user, and may reduce an error caused by a complex algorithm.

Aspects of the present invention can also be embodied as computer-readable codes on a computer-readable recording medium and can be realized in a common digital computer executing the program using a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment and an encryption source code segment (such as data transmission through the Internet). The computer-readable recording medium can also be distributed over network coupled computer systems so that the computer-readable code is stored and executed in a distributed fashion. Moreover, the hard disk drive can be used with a computer, can be a portable drive, and/or can be used with a media player.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A communication method in a cognitive radio (CR) environment, the method comprising:
receiving a signal that is repeatedly transmitted via at least one candidate channel that is not being used;
determining whether the receiving of the signal is due to an existence, in a neighbor cell, of an incumbent user using a CR channel of a target cell; and
changing the CR channel of the target cell when the receiving of the signal is due to the existence of the incumbent user using the CR channel of the target cell.

2. The communication method as claimed in claim 1, wherein the receiving of the signal comprises:
receiving the signal including identical data repeatedly transmitted via a pre-assigned uplink channel and the at least one candidate channel.

3. The communication method as claimed in claim 1, wherein the determining of whether the receiving of the signal is due to the existence of the incumbent user comprises:
determining whether a channel that is currently used in the neighbor cell becomes available; and
determining that the incumbent user using the CR channel of the target cell does not exist in the neighbor cell when the channel that is currently used in the neighbor cell becomes available.

4. The communication method as claimed in claim 3, wherein the determining of whether the receiving of the signal is due to the existence of the incumbent user further comprises:
performing a spectrum sensing process with respect to the channel currently used in the neighbor cell when the channel currently used in the neighbor cell does not become available; and
determining that the incumbent user using the CR channel of the target cell does not exist in the neighbor cell when an incumbent signal is sensed, according to the spectrum sensing process, in the channel currently used in the neighbor cell.

5. The communication method as claimed in claim 4, wherein the determining of whether the receiving of the signal is due to the existence of the incumbent user further comprises:
determining that the incumbent user using the CR channel of the target cell exists in the neighbor cell when the incumbent signal is not sensed, according to the spectrum sensing process, in the channel currently used in the neighbor cell.

6. The communication method as claimed in claim 1, wherein the receiving of the signal comprises:
receiving the signal from a terminal.

7. The communication method as claimed in claim 1, wherein the signal is an uplink signal.

8. A communication method in a CR environment, the method comprising:
receiving a signal that is repeatedly transmitted via a channel that is used by an incumbent user when the incumbent user exists in a neighbor cell and the channel that is used by the incumbent user is a CR channel of a target cell; and
changing the CR channel of the target cell when the signal is received.

9. The communication method as claimed in claim 1, wherein the CR channel is a communication channel between a base station of the target cell and a terminal.

10. The communication method as claimed in claim 8, wherein the CR channel is a communication channel between a base station of the target cell and a terminal.

11. The communication method as claimed in claim 1, wherein the incumbent user is a user having a primary permission to use a particular channel.

12. The communication method as claimed in claim 8, wherein the incumbent user is a user having a primary permission to use a particular channel.

13. The communication method as claimed in claim 8, wherein the signal is an uplink signal.

14. The communication method as claimed in claim 8, wherein the changing of the CR channel of the target cell comprises:
requesting a base station to change the CR channel when the signal is received.

15. A communication apparatus in a CR environment, the apparatus comprising:
a receiving unit to receive a signal that is repeatedly transmitted via at least one candidate channel that is not being used;
a determination unit to determine whether the signal is received due to an existence, in a neighbor cell, of an incumbent user using a CR channel of a target cell; and
a change unit to change the CR channel of the target cell when the signal is received due to the existence of the incumbent user using the CR channel of the target cell.

16. The communication apparatus as claimed in claim 15, wherein the signal includes identical data repeatedly transmitted via a pre-assigned uplink channel and the at least one candidate channel.

17. The communication apparatus as claimed in claim 15, wherein the determination unit:
determines whether a channel that is currently used in the neighbor cell becomes available; and
determines that the incumbent user using the CR channel of the target cell does not exist in the neighbor cell when the channel that is currently used in the neighbor cell becomes available.

18. The communication apparatus as claimed in claim 17, wherein the determination unit:
performs a spectrum sensing process with respect to the channel currently used in the neighbor cell when the channel currently used in the neighbor cell does not become available; and
determines that the incumbent user using the CR channel of the target cell does not exist in the neighbor cell when an incumbent signal is sensed, according to the spectrum sensing process, in the channel currently used in the neighbor cell.

19. The communication apparatus as claimed in claim 18, wherein the determination unit determines that the incumbent user using the CR channel of the target cell exists in the neighbor cell when the incumbent signal is not sensed, according to the spectrum sensing process, in the channel currently used in the neighbor cell.

20. The communication apparatus as claimed in claim 15, wherein the signal is an uplink signal.

21. The communication apparatus as claimed in claim 15, wherein the communication apparatus is a mobile phone.

22. A communication apparatus in a CR environment, the apparatus comprising:
a receiving unit to receive a signal that is repeatedly transmitted via a channel that is used by an incumbent user when the incumbent user exists in a neighbor cell and the channel that is used by the incumbent user is a CR channel of a target cell; and
a change unit to change the CR channel of the target cell when the signal is received.

23. The communication apparatus as claimed in claim 15, wherein the CR channel is a communication channel between a base station of the target cell and a terminal.

24. The communication apparatus as claimed in claim 22, wherein the CR channel is a communication channel between a base station of the target cell and a terminal.

25. The communication apparatus as claimed in claim 15, wherein the incumbent user is a user having a primary permission to use a particular channel.

26. The communication apparatus as claimed in claim 22, wherein the incumbent user is a user having a primary permission to use a particular channel.

27. The communication apparatus as claimed in claim 22, wherein the signal is an uplink signal.

28. The communication apparatus as claimed in claim 22, wherein the change unit changes the CR channel of the target cell by requesting a base station to change the CR channel.

29. The communication apparatus as claimed in claim 22, wherein the communication apparatus is a mobile phone.

30. A communication method in a CR environment, the method comprising:
monitoring one or more channels to determine if an incumbent user in a neighbor cell is using a CR channel of a target cell; and
changing the CR channel of the target cell when the incumbent user is using the CR channel.

31. The communication method as claimed in claim 30, wherein:
the one or more channels are at least one candidate channel that is not being used, and
the monitoring of the one or more channels comprises:
receiving a signal that is repeatedly transmitted via the at least one candidate channel; and
determining whether the receiving of the signal is due to an existence in the neighbor cell of the incumbent user using the CR channel of the target cell.

32. The communication method as claimed in claim 31, wherein the receiving of the signal comprises:
receiving the signal including identical data repeatedly transmitted via a pre-assigned uplink channel and the at least one candidate channel.

33. The communication method as claimed in claim 31, wherein the determining of whether the receiving of the signal is due to the existence of the incumbent user comprises:
determining whether a channel that is currently used in the neighbor cell becomes available; and
determining that the incumbent user using the CR channel of the target cell does not exist in the neighbor cell when the channel that is currently used in the neighbor cell becomes available.

34. The communication method as claimed in claim 33, wherein the determining of whether the receiving of the signal is due to the existence of the incumbent user further comprises:
performing a spectrum sensing process with respect to the channel currently used in the neighbor cell when the channel currently used in the neighbor cell does not become available; and
determining that the incumbent user using the CR channel of the target cell does not exist in the neighbor cell when an incumbent signal is sensed, according to the spectrum sensing process, in the channel currently used in the neighbor cell.

35. The communication method as claimed in claim 34, wherein the determining of whether the receiving of the signal is due to the existence of the incumbent user further comprises:
determining that the incumbent user using the CR channel of the target cell exists in the neighbor cell when the incumbent signal is not sensed, according to the spectrum sensing process, in the channel currently used in the neighbor cell.

36. The communication method as claimed in claim 31, wherein the signal is an uplink signal.

37. The communication method as claimed in claim 30, wherein the monitoring of the one or more channels comprises:
sensing an interference in a channel that is used by the incumbent user when the incumbent user exists in the neighbor cell and the channel that is used by the incumbent user is the CR channel of the target cell.

38. The communication method as claimed in claim 30, wherein the monitoring of the one or more channels comprises:
receiving a signal that is repeatedly transmitted via a channel that is used by the incumbent user when the incumbent user exists in the neighbor cell and the channel that is used by the incumbent user is the CR channel of the target cell.

39. The communication method as claimed in claim 38, wherein the signal is an uplink signal.

40. A communication method that identifies an incumbent user in a neighbor cell of a CR environment, the method comprising:
monitoring a CR channel that is used in a target cell adjacent to the neighbor cell to determine if the incumbent user using the CR channel exists; and
transmitting a signal via one or more channels to inform the target cell that the incumbent user using the CR channel exists if the incumbent user using the CR channel does exist.

41. The communication method as claimed in claim 40, further comprising:
commanding a terminal in the neighbor cell to repeatedly transmit the signal if the incumbent user using the CR channel exists.

42. The communication method as claimed in claim 41, wherein the commanding of the terminal comprises:
commanding a terminal in the neighbor cell most adjacent to the target cell to repeatedly transmit the signal if the incumbent user using the CR channel exists.

43. The communication method as claimed in claim 40, wherein the transmitting of the signal comprises:
transmitting the signal via at least one candidate channel that is not being used.

44. The communication method as claimed in claim 40, wherein the transmitting of the signal comprises:
transmitting the signal via the CR channel.

45. The communication method as claimed in claim 40, wherein the signal is an uplink signal.

46. A communication system that identifies an incumbent user in a neighbor cell of a CR environment, the system comprising:
a monitoring unit to monitor a CR channel that is used in a target cell adjacent to the neighbor cell to determine If the Incumbent user using the CR channel exists; and
a transmitting unit to transmit a signal via one or more channels to inform the target cell that the incumbent user using the CR channel exists if the incumbent user using the CR channel does exist.

47. The communication system as claimed in claim 46, wherein the transmitting unit transmits the signal via at least one candidate channel that is not being used.

48. The communication system as claimed in claim 46, wherein the transmitting unit transmits the signal via the CR channel.

49. A computer-readable medium encoded with the method of claim 30 implemented by a computer.
